(19) United States
(12) Patent Application Publication
(10) Pub. No.: US 2020/0322458 A1
(43) Pub. Date: Oct. 8, 2020

(54) SIGNAL TRANSMISSION METHOD FOR LIGHTWEIGHT REMOTE CONTROL COMMUNICATION PROTOCOL

(71) Applicant: SUPERIOR ELECTRONICS CORPORATION, Taipei City (TW)

(72) Inventors: Shih-Ming Hwang, Irvine, CA (US); James Chien-Jong Hwang, Irvine, CA (US); Lawrence Liang-Lun Hwang, Irvine, CA (US)

(21) Appl. No.: 16/417,585

(22) Filed: May 20, 2019

(30) Foreign Application Priority Data
Apr. 2, 2019 (TW) 108111676

(51) Int. Cl. H04L 29/06; H04L 9/32; H04L 9/12

(52) U.S. Cl. CPC H04L 69/03; H04L 69/02; H04L 9/12; H04L 9/321; H04L 63/0485

(57) ABSTRACT

A signal transmission method for lightweight remote control communication protocol is provided. According to the method, a signal-controlled-end transceiver executes a communication transmission process according to a communication protocol to receive a communication signal. The communication transmission process includes determining whether the payload column of the communication signal is encrypted and determining whether the communication signal is a single-direction or a dual-direction communication signal. Besides, the communication signal further includes a control data and an information data. In this way, when a controlled device receives the communication signal, the control element of the controlled device controls the controlled device according to the control data and the information data. The method can identify signal-direction signals or dual-direction signals, encrypted signals or non-encrypted signals, and transmit the control data and the information data to the controlled device on a lightweight data basis, and so can achieve accurate control and other technical effects.

### BACKGROUND OF THE INVENTION

### 1. Field of the Invention

The present invention relates to a signal transmission method between a signal-control-end transceiver and a signal-controlled-end transceiver, in particular to a communication protocol between a signal-control-end transceiver and a signal-control-end transceiver, applicable to identify encrypted signals and non-encrypted signals, signal-direction signals and dual-direction signals, transmit signals carrying lightweight data, and transmit control data and information data in a single signal.

### 2. Description of the Prior Art

With advance of technology, wireless communication technologies are greatly improved. In order to increase the convenience of people's daily life, it is common to use wireless communication technologies to remotely control or activate various controlled devices (e.g. televisions, cars, air conditioners, garage doors, etc.).

When a user implements data or control signal transmission via point-to-point remote connection or control, the remote control devices need a communication protocol to provide the regulations for these devices to transmit data with one another. However, currently available communication protocols (e.g. Bluetooth protocol) are too complicated, so the devices need a lot of time to transmit signals to one another, which increases the power consumption of the devices and may likely not conform to the communication regulations enacted. If these communication protocols are simplified to provide lightweight communication protocols, these lightweight communication protocols cannot effectively identify single-direction signals or dual-direction signals, identify encrypted signals or non-encrypted signals, carry data signals and control signals at a time, flexibly adjust signal lengths, etc.

Thus, it has become important to provide a lightweight communication protocol with multiple functions so as to solve the above problems.

### SUMMARY OF THE INVENTION

To achieve the foregoing objective, the present invention provides a signal transmission method for a lightweight remote control communication protocol. According to the method, a signal-controlled-end transceiver executes a communication transmission process to receive a communication signal according to a communication protocol. The communication transmission process includes determining whether the payload column of the communication protocol is encrypted. If the payload column is encrypted, the signal-controlled-end transceiver executes a decryption process and an encryption identification process, and confirms whether the communication signal is a single-direction communication signal or a dual-direction communication signal. When the communication signal is a dual-direction communication signal, the signal-controlled-end transceiver generates a feedback signal and transmits the feedback signal to the signal-controlled-end transceiver or a target device for the signal-controlled-end transceiver or the target device to confirm whether the communication signal is received. In addition, the communication signal further includes a control data and an information data. In this way, when a controlled device receives the communication signal, the control element of the controlled device controls the controlled device according to the control data and the information data so as to effectively identify single-direction signals or dual-direction signals, identify encrypted signals or non-encrypted signals, transmit signal carrying lightweight data, transmit control signals and information data by one signal at a time, and flexibly adjust signal lengths, etc.

To achieve the foregoing objective, the present invention provides a signal transmission method for lightweight remotely control communication protocol, applicable to the data transmission between a signal-control-end transceiver and at least one signal-controlled-end transceiver corresponding thereto; the method includes:

Transmitting a communication signal according to a communication protocol by the signal-control-end transceiver in order to determine the signal-controlled-end transceiver, within the effective range of the communication signal, corresponding to the source identification of the communication signal;

Executing a communication transmission process to receive the communication signal according to the communication protocol by the signal-controlled-end transceiver; the communication transmission process includes:

Checking the determination flag of the command frame of the communication signal by the signal-controlled-end transceiver in order to confirm whether the communication signal is a single-direction communication signal or a dual-direction communication signal;

Checking the encryption flag of the command frame by the signal-controlled-end transceiver so as to confirm whether the payload column of the communication protocol is encrypted; and

Executing a decryption process and an encryption identification process by the signal-controlled-end transceiver when the signal-controlled-end transceiver determines the payload column is encrypted in order to confirm whether the communication signal is a real communication signal;

Finishing the communication transmission process by the signal-controlled-end transceiver.

Preferably, the encryption identification process includes:

Checking whether the encryption information of the payload column conforms to the message authentication code of the signal-controlled-end transceiver by the signal-controlled-end transceiver; and

Confirming that the communication signal is the real communication signal by the signal-controlled-end transceiver when the signal-controlled-end transceiver determines that encryption information conforms to the message authentication code.

Preferably, the payload column includes a control frame and a message frame; the control frame includes a control data and the message frame comprises an information data.

Preferably, when the signal-controlled-end transceiver finishes the communication transmission process, the signal-controlled-end transceiver transmits the communication signal to a controlled device; the control element of the controlled device controls the controlled device according to the control data of the communication signal, and the processing element of the controlled device regulates the control method that the control element uses to control the controlled device according to the information data of the communication signal.

Preferably, the payload column further includes a sequence frame for recording the transmission sequence of the communication signal.

Preferably, the encryption identification process includes:

Checking the transmission sequence of the communication signal of the sequence frame by the signal-controlled-end transceiver in order to determine whether the communication signal is the real communication signal.

Preferably, when the signal-controlled-end transceiver finishes the communication transmission process and the signal-controlled-end transceiver confirms that the communication signal is the real communication signal, the signal-controlled-end transceiver transmits the communication signal to a controlled device.

Preferably, the communication transmission process includes:

Checking whether the error identification of the communication signal conforms to the error code of the signal-controlled-end transceiver by the signal-controlled-end transceiver; and

Abandoning the communication signal by the signal-controlled-end transceiver when the signal-controlled-end transceiver determines that the error identification fails to conform to the error code.

Preferably, the communication signal includes a destination identification for recording an identification code transmitting to the signal-controlled-end transceiver or a target device.

Preferably, the communication signal includes a packet type frame for setting the packet type of the communication signal.

Preferably, when the signal-controlled-end transceiver confirms that the communication signal is a dual-direction communication signal, the signal-controlled-end transceiver generates a feedback signal and transmits the feedback signal to the signal-control-end transceiver or a target device.

Preferably, the communication signal includes a pre-amble, a sync frame and a length frame; the pre-amble records a timing sync information; the sync frame records a sync connection information; the signal-controlled-end transceiver establishes a sync connection with the signal-control-end transceiver according to the timing sync information and the sync connection information; the length frame records the total length of the communication signal.

Via the technical features disclosed above, the present invention not only can achieve the aforementioned technical effects, but also can increase the transmission speed of data signals, reduce the power consumption of the signal-control-end transceiver and the signal-controlled-end transceiver, and maintain conformance to the communications regulatory bodies.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is the system connection relation diagram in accordance with the present invention.

FIG. 2 is the flow chart of identifying the single-direction signal or the dual-direction signal in accordance with the present invention.

FIG. 3 is the timing diagram of the signal transmission of the single-direction signal in accordance with the present invention.

FIG. 4 is the timing diagram of the signal transmission of the dual-direction signal in accordance with the present invention.

FIG. 5A is the schematic view of the communication format of the non-encrypted single-direction signal in accordance with the present invention.

FIG. 5B is the schematic view of the communication format of the non-encrypted dual-direction signal in accordance with the present invention.

FIG. 6 is the flow chart of the encryption identification in accordance with the present invention.

FIG. 7A is the schematic view of the communication format of the encrypted single-direction signal in accordance with the present invention.

FIG. 7B is the schematic view of the communication format of the encrypted dual-direction signal in accordance with the present invention.

FIG. 8 is the flow chart of the identification process of single-direction/dual-direction signals and encrypted/non-encrypted statuses in accordance with the present invention.

### DETAILED DESCRIPTION OF THE PREFERRED EMBODIMENT

The following description is about embodiments of the present invention; however it is not intended to limit the scope of the present invention.

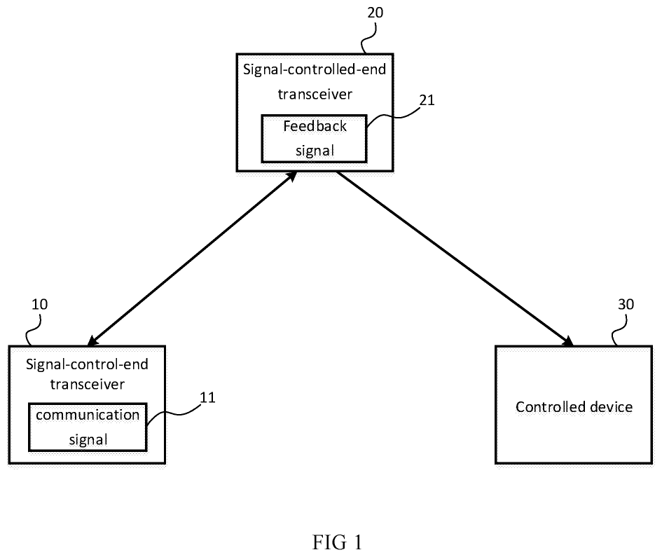

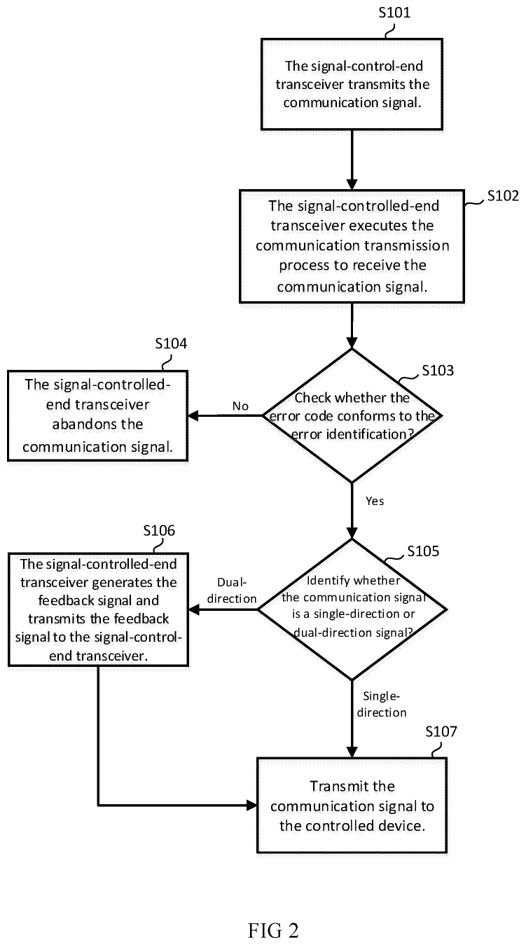

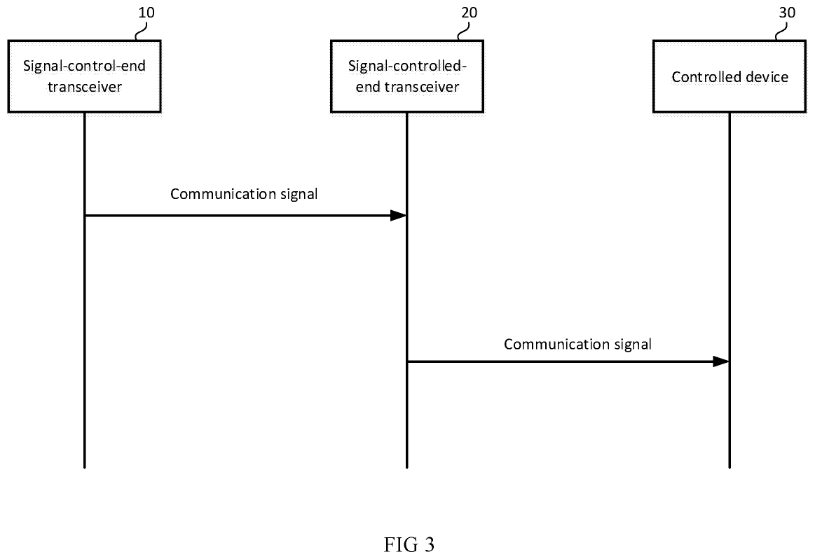

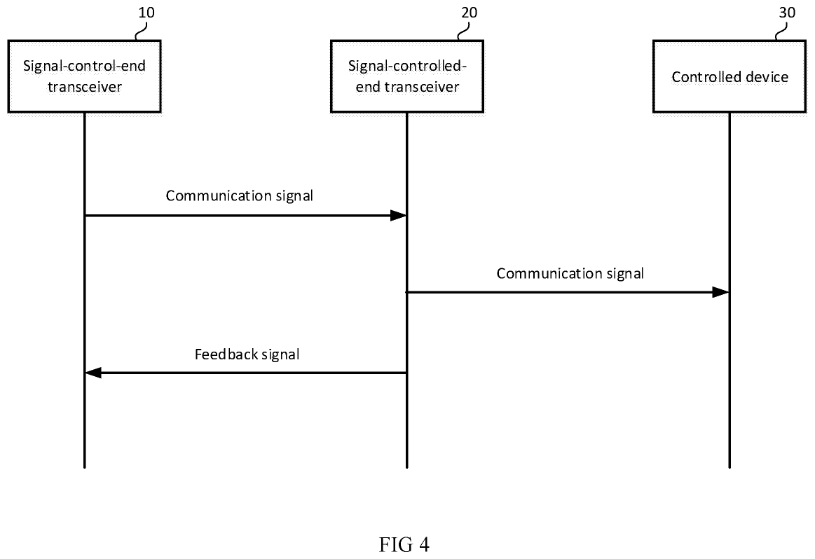

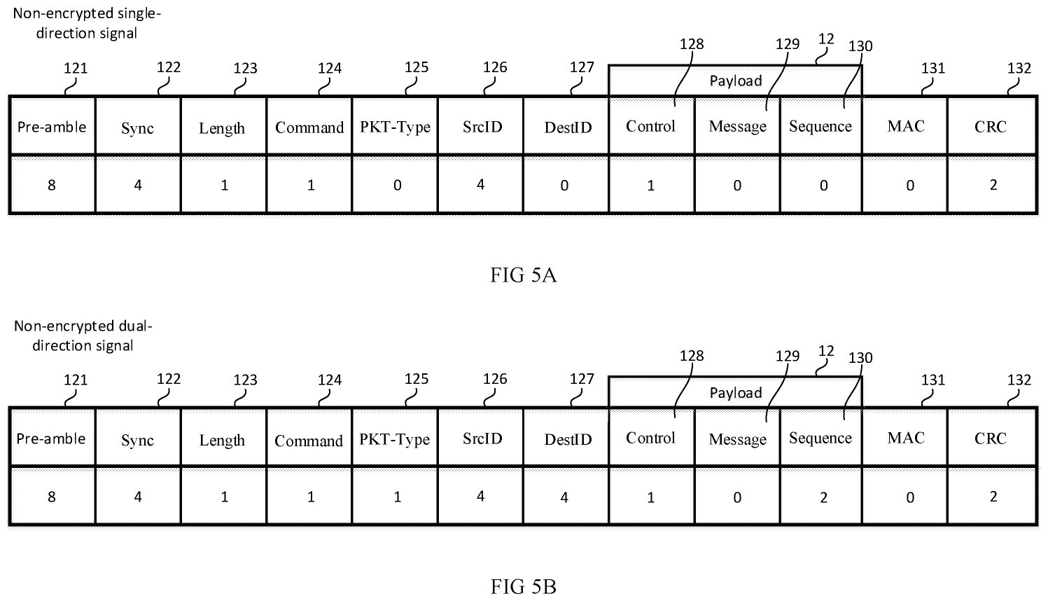

Please refer to FIG. 1˜FIG. 5, which are the system connection relation diagram, the flow chart of identifying the single-direction signal or the dual-direction signal, the timing diagram of the signal transmission of single-direction signals, the timing diagram of the signal transmission of the dual-direction signal, the schematic view of the communication format of the non-encrypted single-direction signal, and the schematic view of the communication format of the non-encrypted dual-direction signal in accordance with the present invention. As shown in FIG. 1˜FIG. 5, the present invention provides a signal transmission method for a lightweight remote control communication protocol, applicable to the data transmission between a signal-control-end transceiver 10 and a signal-controlled-end transceiver 20. The method uses the signal-control-end transceiver 10 to transmit a communication signal 11 (S101). When the signal-control-end transceiver 10 transmits the communication signal 11, the signal-control-end transceiver 10 outputs the communication signal 11 according to the structure of a communication protocol. More specifically, the communication signal 11 has a plurality of frames, including a pre-amble 121, a sync frame 122, a length frame 123, a command frame 124, a packet type (PKT-Type) frame 125, a source identification 126 (SrcID), a destination identification (DestID) 127, a control frame 128, a message frame 129, a sequence frame 130, a message authentication code (MAC) frame 131, and a cyclic redundancy check (CRC) frame 132; each frame has its own function. Thus, when outputting the communication signal 11, the signal-control-end transceiver 10 can generate the communication signal 11 by combining some of these frames according to the desired function. Accordingly, the communication signals 11 with different functions, such as encrypted signal, non-encrypted signal, single-direction signal, or dual-direction signal, will have different signal lengths. When the communication signal 11 is outputted, the signal-control-end transceiver 10 searches the signal-controlled-end transceiver 20 within the effective range of the communication signal 11 and corresponding to the source identification of the communication signal 11, and transmits the communication signal 11 to the signal-controlled-end transceiver 20.

However, when the signal-controlled-end transceiver 20 receives the communication signal 11, the signal-controlled-end transceiver 20 executes a communication transmission process according to the communication protocol in order to receive the communication signal 11 (S102); more specifically, the communication transmission process includes:

The signal-controlled-end transceiver 20 checks whether the error identification of the communication signal 11 conforms to the error code of the signal-controlled-end transceiver 20. More specifically, the CRC frame 132 of the communication signal 11 includes the error code. When receiving the error code, the signal-controlled-end transceiver 20 checks whether the error code conforms to the error identification (S103). If the signal-controlled-end transceiver 20 determines that the error identification fails to conform to the error code, the signal-controlled-end transceiver 20 abandons the communication signal 11 (S104).

The signal-controlled-end transceiver 20 checks the determination flag of the command frame 124 of the communication signal 11. The determination flag is primarily used to determine whether the communication signal 11 is a single-direction signal or a dual-direction signal. Therefore, the signal-controlled-end transceiver 20 cam determine whether the communication signal 11 is a single-direction signal or a dual-direction signal according to the determination flag (S105). When the signal-controlled-end transceiver 20 confirms that the communication signal 11 is a dual-direction signal, the signal-controlled-end transceiver 20 generates a feedback signal 21 and transmits the feedback signal 21 to the signal-control-end transceiver 10 or a target device (S106).

When the communication signal 11 is a dual-direction signal, the destination identification 127 of the communication signal 11 is an identification code used to record the device where the signal is returned (e.g. the signal-control-end transceiver 10 or the target device). In this way, after generating the feedback signal 21, the signal-controlled-end transceiver 20 can transmit the feedback signal 21 to the signal-control-end transceiver 10 or the target device according to the destination identification 127.

The communication signal 11 includes a payload column 12 and the payload column 12 includes the control frame 128, the message frame 129 and the sequence frame 130. The control frame 128 further includes a control data and the message frame 129 includes an information data; further, the sequence frame 130 is used to record the transmission sequence of the communication signal 11. In this way, when the communication signal 11 is a dual-direction signal, the sequence frame 130 keeps recording the transmission sequence of the communication signal 11 in order to identify the sequence of the transmitted and received signals.

When finishing the communication transmission process, the signal-controlled-end transceiver 20 transmits the communication signal 11 to a controlled device 30 (S107). More specifically, the control element of the controlled device can control the controlled device 30 according to the control data of the communication signal 11; the processing element of the controlled device 30 can regulate how the control element controls the controlled device 30 according to the information data of the communication signal 11. For example, the information data could be used to turn the TV channel to the 64th channel and the control data to turn on the TV. In this case, when the TV receives the control data and the information data, the TV is turned on and the TV channel is turned to 64th channel. In another example, the information data could be used to set the activation time to 17:50 and the control data to turn on the air conditioner. In this case, when the air conditioner receives the control data and the information data, the air conditioner will be turned on at 17:50.

Moreover, the pre-amble 121 of the communication signal 11 is used to record a timing sync information and the sync information sequence frame 122 is used to record a sync connection information. In this way, the signal-controlled-end transceiver 20 can establish a sync connection to the signal-control-end transceiver 10 according to the timing sync information and the sync connection information. The length frame 123 is used to record the total length of the communication signal 11 and the PKT-Type frame 125 is used to set the packet type of the communication signal 11.

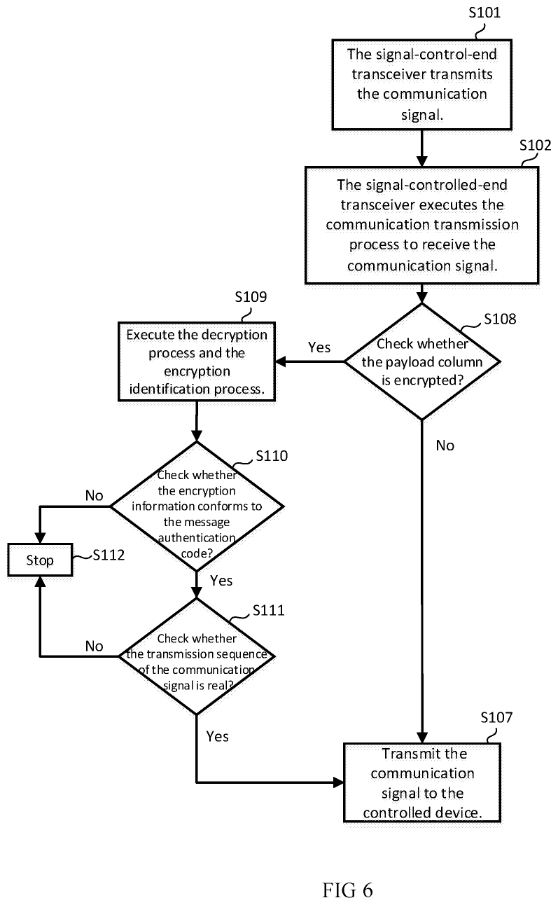

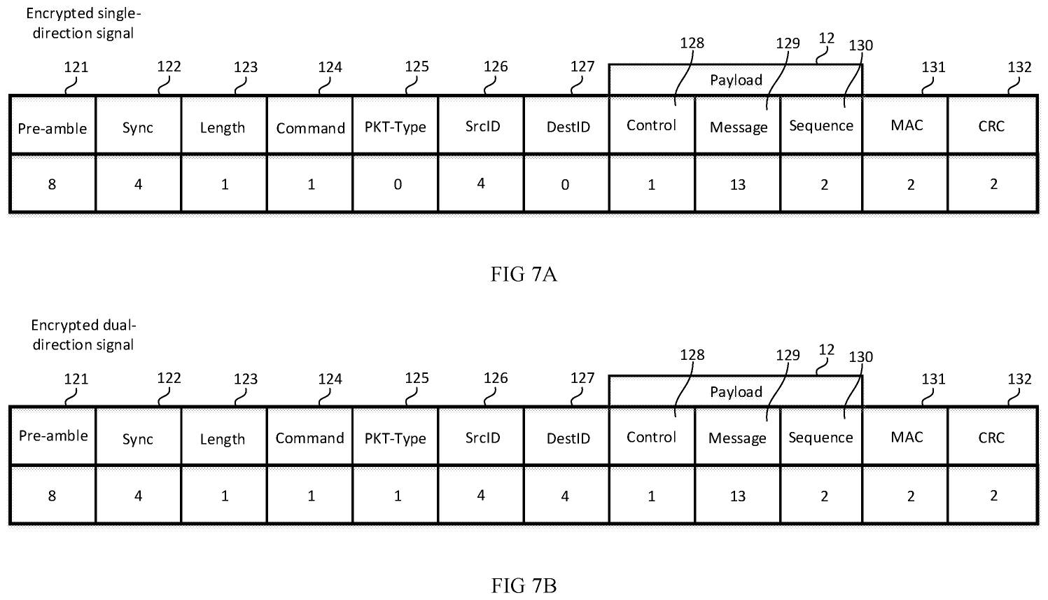

Please refer to FIG. 6 and FIG. 7, which are the flow chart of the encryption identification, the schematic view of the communication format of the encrypted single-direction signal, and the schematic view of the communication format of the encrypted dual-direction signal in accordance with the present invention. As shown in FIG. 6 and FIG. 7, the aforementioned communication transmission process further includes:

The signal-controlled-end transceiver 20 checks the encryption flag of the command frame 124 so as to confirm whether the payload column 12 of the communication signal 11 is encrypted (S108). When confirming that the payload column 12 of the communication signal 11 is encrypted, the signal-controlled-end transceiver 20 executes a decryption process and an encryption identification process via the MAC frame 131 and the sequence frame 130 so as to confirm whether the communication signal 11 is a real communication signal.

More specifically, the encryption identification process includes the following steps:

The signal-controlled-end transceiver 20 checks whether the encrypted payload information (column 12) conforms to the message authentication code of the signal-controlled-end transceiver 20 (S110).

When confirming that the encryption information conforms to the message authentication code, the signal-controlled-end transceiver 20 confirms that the communication signal 11 is a real communication signal.

The signal-controlled-end transceiver 20 checks the transmission sequence (S111) of the sequence frame 130 in order to confirm the timing order.

More specifically, regarding the aforementioned identification methods by the encryption information and the message authentication code, and the transmission sequence confirmation method via the record in the sequence frame 130, if the identification result of one of the above methods is incorrect, the communication signal 11 is determined to be an incorrect communication signal. Then, the communication transmission process can be elected to be stopped (S112).

When the signal-controlled-end transceiver 20 finishes the communication transmission process and confirms that the communication signal 11 is a real communication signal 11, the signal-controlled-end transceiver 20 transmits the communication signal 11 to the controlled device 30 (S107) so as to drive the control element to control the controlled device 30 according to the control data of the communication signal 11. Meanwhile, the processing element regulates the control method of the control element controlling the controlled device 30 according to the information data of the communication signal 11.

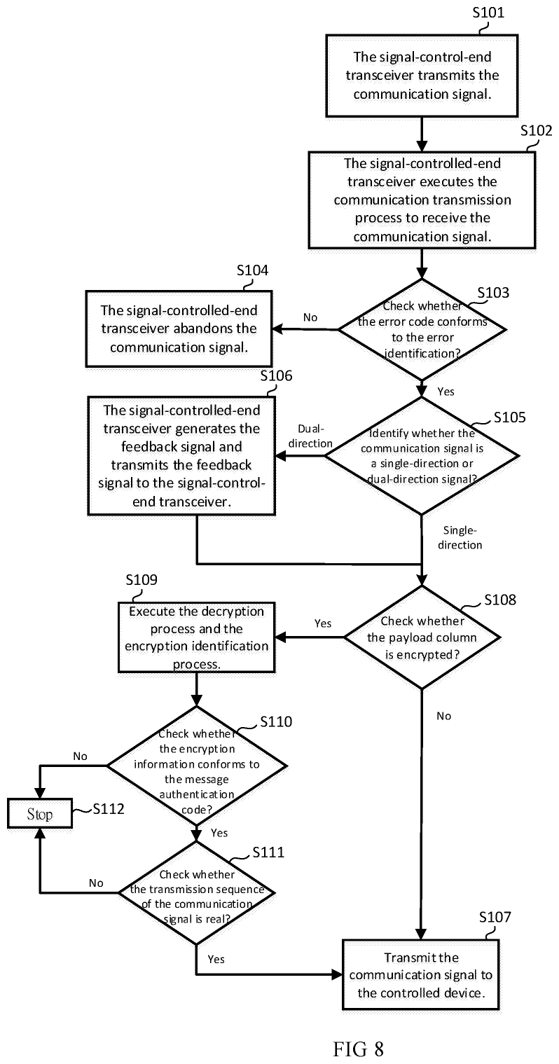

Please refer to FIG. 8, which is the flow chart of the identification process of single-direction/dual-direction signals and encrypted/non-encrypted statuses in accordance with the present invention. As shown in FIG. 8, the present invention can execute one of the above identification processes of the single-direction signal/dual-direction signal and the encryption/non-encryption status, or simultaneously execute all identification processes. The above figures are just for illustration, so the identification processes of the single-direction signal/dual-direction signal and the encryption/non-encryption status are descripted separately. Besides, the step order shown in the above figures should not be limited; the step order can be changed according to actual requirements. For example, the signal-controlled-end transceiver 20 can execute the identification of the single-direction/dual-direction signals and then execute the identification of the encryption/non-encryption statuses. Alternatively, the signal-controlled-end transceiver 20 can execute the identification of the encryption/non-encryption statuses and then execute the identification of the error code.

The above disclosure is related to the detailed technical contents and inventive features thereof Those skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A signal transmission method for lightweight remote control communication protocol, applicable to a data transmission between a signal-control-end transceiver and at least one signal-controlled-end transceiver corresponding thereto, wherein the method comprises:
transmitting a communication signal according to a communication protocol by the signal-control-end transceiver, in order to identify the signal-controlled-end transceiver, within an effective range of the communication signal, corresponding to a source identification of the communication signal;
executing a communication transmission process to receive the communication signal according to the communication protocol by the signal-controlled-end transceiver, wherein the communication transmission process comprises:
checking a determination flag of a command frame of the communication signal by the signal-controlled-end transceiver, in order to confirm whether the communication signal is a single-direction communication signal or a dual-direction communication signal;
checking an encryption flag of the command frame by the signal-controlled-end transceiver, so as to confirm whether a payload column of the communication signal is encrypted; and
executing a decryption process and an encryption authentication process by the signal-controlled-end transceiver, when the signal-controlled-end transceiver confirms the payload column is authenticated, in order to confirm whether the communication signal is a real communication signal;

2. The signal transmission method for lightweight remote control communication protocol of claim 1, wherein the encryption identification process comprises:
checking whether the encrypted payload conforms to an message authentication code of the signal-controlled-end transceiver by the signal-controlled-end transceiver; and
confirming the communication signal is the real communication signal by the signal-controlled-end transceiver, when the signal-controlled-end transceiver determines encrypted payload conforms to the message authentication code.

3. The signal transmission method for lightweight remote control communication protocol of claim 1, wherein the payload column comprises a control frame and a message frame; the control frame comprises a control data and the message frame comprises an information data.

4. The signal transmission method for lightweight remote control communication protocol of claim 3, wherein when the signal-controlled-end transceiver finishes the communication transmission process, the signal-controlled-end transceiver transmits the communication signal to a controlled device, wherein a control element of the controlled device controls the controlled device according to the control data of the communication signal, and a processing element of the controlled device regulates a control method of the control element, to control the controlled device according to the information data of the communication signal.

5. The signal transmission method for lightweight remote control communication protocol of claim 3, wherein the payload column further comprises a sequence frame for recording a transmission sequence of the communication signal.

6. The signal transmission method for lightweight remote control communication protocol of claim 5, wherein the encryption identification process comprises:
checking the transmission sequence of the communication signal of the sequence frame by the signal-controlled-end transceiver in order to determine timing order of the real communication signal.

7. The signal transmission method for lightweight remote control communication protocol of claim 2, wherein when the signal-controlled-end transceiver finishes the communication transmission process and the signal-controlled-end transceiver confirms the communication signal is the real communication signal, the signal-controlled-end transceiver transmits the communication signal to a controlled device.

8. The signal transmission method for lightweight remote control communication protocol of claim 3, wherein when the signal-controlled-end transceiver finishes the communication transmission process and the signal-controlled-end transceiver confirms the communication signal is the real communication signal, the signal-controlled-end transceiver transmits the communication signal to a controlled device.

9. The signal transmission method for lightweight remote control communication protocol of claim 1, wherein the communication transmission process comprises:
checking whether an error identification of the communication signal conforms to an error code of the signal-controlled-end transceiver by the signal-controlled-end transceiver; and
abandoning the communication signal by the signal-controlled-end transceiver, when the signal-controlled-end transceiver determines the error identification fails to conform to the error code.

10. The signal transmission method for lightweight remote control communication protocol of claim 1, wherein the communication signal comprises a destination identification for recording an identification code transmitting to the signal-controlled-end transceiver or a target device.

11. The signal transmission method for lightweight remote control communication protocol of claim 1, wherein the communication signal comprises a packet type frame for setting a packet type of the communication signal.

12. The signal transmission method for lightweight remote control communication protocol of claim 1, wherein when the signal-controlled-end transceiver confirms the communication signal is the dual-direction communication signal, the signal-controlled-end transceiver generates a feedback signal and transmits the feedback signal to the signal-control-end transceiver or a target device.

13. The signal transmission method for lightweight remote control communication protocol of claim 1, wherein the communication signal comprises a pre-amble, a sync frame and a length frame; the pre-amble records a start timing sync information; the sync frame records a sync connection information; the signal-controlled-end transceiver establishes a sync connection with the signal-control-end transceiver according to the start timing sync information and the sync connection information; and the length frame records a total length of the communication signal.
